(19) United States
(12) Patent Application Publication
(10) Pub. No.: US 2022/0188925 A1
(43) Pub. Date: Jun. 16, 2022

(54) Method and System for Data Futures Platform

(71) Applicant: Data Donate Technologies, Inc., New York, NY (US)

(72) Inventors: Alfred Blair Blaikie, III, Tinton Falls, NJ (US); Nathaniel T. Bradley, Tucson, AZ (US); Joshua S. Paugh, Tucson, AZ (US)

(73) Assignee: Data Donate Technologies, Inc., New York, NY (US)

(21) Appl. No.: 17/441,847

(22) PCT Filed: Mar. 27, 2020
(86) PCT No.: PCT/US20/25495

§ 371 Date: Sep. 22, 2021

Related U.S. Application Data
(60) Provisional application No. 62/908,252, filed on Sep. 30, 2019.
(60) Provisional application No. 62/845,057, filed on May 8, 2019.
(60) Provisional application No. 62/826,457, filed on Mar. 29, 2019.

(51) Int. Cl. G06Q 40/04; G06Q 30/02

(52) U.S. Cl. CPC G06Q 40/04; G06Q 2220/00; G06Q 30/0206

(57) ABSTRACT

A system, method, and platform for performing transactions for data. The data is grouped. The data is associated with a platform. Transaction information for the data is received. One or more transactions are performed based on the transaction information. The verification of the transaction is provided.

### PRIORITY

This application claims priority to U.S. Provisional Patent Application Nos. 62/826,457, 62/845,057, and 62/908,252 filed Mar. 29, 2019, May 8, 2019, and Sep. 30, 2019, respectively, each of which is hereby incorporated by reference in their entirety.

### BACKGROUND

### I. Field of the Disclosure

The illustrative embodiments relate to personal data management. More specifically, but not exclusively, the illustrative embodiments relate to a system, method, apparatus, and platform for the futures valuation and management of personal data.

### II. Description of the Art

In recent years, data security, cyber-attacks and big data breaches have led to the development of technology initiatives to secure data and make it available for users, including blockchain, cryptocurrencies, fire walls, and security and encryption technologies. These technologies have largely fallen short of protecting or properly capturing the full spectrum of available commercial and consumer data. The commercial Internet is still largely dependent on digital advertisement revenue derived from user or personal data that is typically monetized through advertising and resulting commercial and consumer product sales. User data is being captured, searched and used in blind and behavioral targeted ad revenue production and delivery by the big data companies. Search engines, web destinations, and physical real-world sources of data are abundant and grossly underserved in the fields of capture, valuation, and monetization. Big data companies collect, analyze, verify and sell commercial and consumer data across all known web environments. The data is monetized by collecting and tracking interactions across an array of platforms, sites, devices, questionnaires, surveys and so forth.

Often, the current mechanisms fall short in the ability to value the resulting data, in real-time and in the future, and do not provide accurate data capture or network or exchanges for data purchasing, development, and transaction. Commercial and consumers' online profile data is commonly generated and monetized from commercial and consumer web searches, profile data, social media profiles, and online surveys that generate revenue through advertisement delivery with no compensation to the actual owners of the data, the individual commercial and consumers/users, commercial and consumer groups, organizations, and data generators themselves. Likewise, monetizing options for business, commercial, and consumer data are very limited.

### SUMMARY OF THE DISCLOSURE

The illustrative embodiments provide a system, method, and platform for performing transactions for data. The data is grouped. The data is associated with a platform. Transaction information for the data is received. One or more transactions are performed based on the transaction information. The verification of the transaction is provided. Another embodiment provides a processor for executing a set of instructions and a memory storing a set of instructions configured to perform the method herein described.

The illustrative embodiments provide a system, method, and platform for monetizing data. A selection is received from a user to monetize data associated with the user. The data associated with user is compiled. A security token is generated including the data. The data is monetized utilizing the security token in accordance with the selection.

In other embodiments, the data may include digital profiles that are monetized for data. Data validation may be performed through user opt-ins that are identified and confirmed by the user. Token based compensation for consumer data allows for the direct control and monetization of their data (e.g., web data, application data, profiles, personal measurements, readings, etc.). Compensation may be performed through digital currencies, hard currencies, charitable contributions, and tax deductions. The earnings for a user may also be donated. Users may be rewarded for additional data uploads, updates, additions, amendments, surveys/questionnaire fulfillment, and so forth. The tokens may be utilized to pay a vendor or third party for a product, service, system, or data, secure a digital asset, tracking the life of an asset, share a stake in an asset or company, participate in an initial coin offering, receive a reward, maintaining and managing a digital asset, make a charitable contribution, or receive a tax deduction.

Another embodiment provides a system, method, and platform for performing transactions for data. The data is collected and grouped. The data is associated with each unique user profile and unique profile data element within the user profile record stored for access and monetization by the platform. Transaction information for the data is received, tokenized, valued and placed on various data markets for sale to any data acquirers. One or more transactions are performed based on the various proprietary data value methodologies for tokenized data and sales of each data element in each user profile transaction information. The monetization of each data elements is confirmed for each data elements monetized in the transaction and a verification record of the transaction is provided. Another embodiment provides a processor for executing a set of instructions and a memory storing a set of instructions configured to perform the method herein described.

The illustrative embodiments provide a system, method, and platform for tokenizing and monetizing data in real time and through the sale of data futures. A user data profile, corporate data profile, data pool or data selection is received from a user to monetize data associated with the user. The data associated with user is compiled and valued based on the current value of that data based on data completeness or if desired data points are contained in the data profile. A security token is generated based on the data value at the time of data purchase by a 3^{rd} party data purchasers, advertisers or other approved entities that may have a desire to obtain specific commercial and consumer datapoints. The data is monetized utilizing the security and the value of the data token in accordance with the selection.

In other embodiments, the data may include digital profiles that are monetized for specific data or as data profile groupings. Data validation may be performed through user platform and profile user opt-ins that are identified and confirmed by the user for the purpose of full control of where user data is accessed and monetized. Token based compensation for commercial and consumer data allows for the direct control and monetization of their data (e.g., web data, application data, profiles, personal measurements, health data, financial data, commercial and consumer interest, commercial and consumer purchase intent, readings, corporate data, financial data, accounting data, data pools etc.). Compensation may be performed through digital currencies, hard currencies, charitable contributions, and tax deductions. The earnings for a user may also be donated. Users may be rewarded for additional data uploads, updates, additions, amendments, surveys/questionnaire fulfillment, data point completeness and so forth. The tokens may be utilized to pay a vendor or third party for a product, service, system, or data, secure a digital asset, tracking the life of an asset, share a stake in an asset or company, participate in an initial coin offering, receive a reward, maintaining and managing a digital asset, make a charitable contribution, or receive a tax deduction.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing user data in accordance with an illustrative embodiment;

FIG. 2 further illustrates portions of the system of FIG. 1 in accordance with an illustrative embodiment;

FIG. 3 is a flowchart of a process for monetizing data in accordance with an illustrative embodiment;

FIG. 4 is a flowchart of a process for managing compensation for data in accordance with an illustrative embodiment;

FIG. 5 is a flowchart of a process for performing transactions in accordance with an illustrative embodiment;

FIG. 6 is a flowchart of processing data for a data derivative market in accordance with an illustrative embodiment;

FIGS. 7 and 8 are pictorial representations of user interfaces in accordance with an illustrative embodiment;

FIG. 9 is a pictorial representation of a platform 900 for monetizing data in accordance with an illustrative embodiment;

FIG. 10 is a flowchart of a process for monetizing data in accordance with an illustrative embodiment; and

FIG. 11 depicts a computing system in accordance with an illustrative embodiment.

### DETAILED DESCRIPTION OF THE DISCLOSURE

The illustrative embodiments provide a system, method, platform, and network for encrypting, securing, developing, and managing data valuations, transactions, data future transactions and utilizations. The data may be accessible from any number of authorized and connected devices and are only accessible to data purchasers through user profile controlled and approved data transactions. The illustrative embodiments allow users/commercial and consumers, commercial and consumer groups, companies, organizations, entities, governments, and other parties worldwide to develop data monetization strategies and the conversion of any value based data, data points or data pools into a common transactable token currency. The platform-based conversion of tokenized data enables monetization of all types of data into any number of currencies and allows for the price to be set for an anonymous exchange of data through broker transactions. For example, this may include the curation, acquisition, development, creation, and market valuation of secured tokens to protect, monetize, control, and perform transactions with data. The illustrative embodiments may be utilized to donate data or the date is utilization for tax benefits or to support charitable organizations. The illustrative embodiments may be utilized to value data in the present and future in a data futures marketplace where data holders may tokenize their data for monetization, data futures traders may buy and sell contracts based on data value in the present or in a data futures market where data is traded and sold as a commodity with a hedge bet placed on the value of the data in the future. The futures hedge is placed for a specific date in the future and the data is traded with the intent that the value of the data will increase by the time the data is monetized on the date specified in the data future contract on the value of the data in the data futures market.

As a result, data owners are empowered with a system, method, and platform for capturing, identifying, monetizing, converting, utilizing, and improving the ability to tokenize, value and monetize data in the present and the future based on the data future marketplace data price for each data monetization.

As referenced herein, data refers to the personal, corporate, advertising, commercial and consumer, health, stock, financial, or commercial data, user profiles, web profiles, search profiles, application profiles, accounting, historical data, operational data, live data, incremental data, and other information applicable to a user, commercial and consumer, entity, data vendor, data house, device, system, or other party. The data may represent personal, commercial, or other types of data. The illustrative embodiments comply with all applicable data privacy and administration rules, laws, and best practices. Any number of mobile devices, computers, machines, servers, arrays, or so forth may be utilized to implement the illustrative embodiments. A user may objectify, value, tokenize any profile datapoint contained in his/her data profile and convert and list upon an exchange data objects and enables conversion of all applicable data into data objects that may be controlled, valued, and monetized in commercial exchange transactions. The illustrative embodiments also provide the user the ability to control and value data generation and the seamless utilization and monetization of the data. For example, algorithmic processing may determine how and when online and digital data is utilized and monetized, the price point or fair data valuation based on applicable pricing (e.g., demographic, global, location, utilization, data point desirability and marketability, etc.) based on going rates, principles of supply and demand, market economics, market analysis, machine learning, exchanges, auctions, real-time bidding, artificial intelligence, and so forth. Relevant information regarding data utilization may be acquired in real-time, based on historical transactions/archives, a data futures market, buying and selling prices, or other applicable information or data that informs the current or future value of a data sale or transaction. The illustrative embodiments allow the end user to select access levels to each data point to better inform user advertisement preferences and may also grant data access to data purchasers, vendors or companies that coincide with their demographics, opinions, behaviors, beliefs, social structure, environmental purchase plans, and real-world desires.

The illustrative embodiments may be utilized to perform a transaction for the data. The data may be grouped, associated to provide present data value and future data value, which may be tokenized and commoditized for any number of trades, exchanges, purchases, donations, or other transactions. The data may be associated with a platform for transactions involving the data. The transaction may be performed automatically or based on user input, feedback, instructions, or commands.

One embodiment provides a blockchain-based and securitized virtual reality where tokens representing refined data objects are valued within a user interface and that system gives users the ability to control, monetize, and/or choose to make proceeds donatable to charity or causes of their choice. The interface allows user to list any or all of the represented data objects upon a private or public exchange where the data is represented in a ticker or short name that provides price and object parameters for purchase. The proceeds from the sale of data are achieved when the ticker is purchased for the sale price, the securitized token is delivered to buyer, and data objects are made available for the buyer's access. The illustrative embodiments of the data refinery provide a curation of data objects that are collected from historical, or in real-time from data sources identified within the system and stored securely as data objects. The valuation of tokenized data objects are priced by the seller using clear compensation and renumeration guidelines and then listed to the exchange via short name or ticker that is made available for purchase to registered buyers.

One embodiment provides a blockchain based security token system that gives commercial and consumers the ability to control, value, monetize, and/or donate any or all of the proceeds from the utilization, sale, or sharing of their profile data. The illustrative embodiments curate or collect data in real-time from users based on an opt-in system with clear compensation and renumeration guidelines. For example, any number of computing or communications devices, platforms, applications, or so forth may be utilized to capture the data.

The security tokens utilized may represent any number of existing, custom/proprietary data points and data valuation methodologies, to provide value-based tokens for each user profile-controlled data points in a profile. In one embodiment, formatted, structured, or unstructured data may be converted into an encrypted token that represents, includes, or references the applicable data. The user's security interest in a data asset may be represented in the form of a token. Data across numerous fields and with different utilizations may be captured in a token (or tokenized). For example, intelligence, counterintelligence, commercial and consumer profiles, commercial and consumer/user, private, public, and other types of data may be captured and monetized. For example, the illustrative embodiments may provide a data management system that allows an asset, such as ownership of a digital profile to be tokenized as an asset that may be tracked, grown, and expanded through an opt in submission from multiple sources and monetized digitally through an e-commerce platform.

The security tokens may be issued, regulated, managed, and distributed by a platform to comply with the existing regulatory framework. The platform may provide a data monetization process for creating and performing data future transactions between buyers and sellers (e.g., similar to a stock trading platform or commodity futures platform).

The illustrative embodiments may apply pricing based on a set price range, guidelines, industry-standard, data desirability, marketability, advertising targeting success rates and market rate. The illustrative embodiments provide a transformational method for valuing and monetizing any and all categories of data in the form of a token may allow the user to directly control and monetize their data in a transparent and secure blockchain platform. Commercial and consumers may receive security tokens in several ways when they sign up via the platform to participate in the system/service, when and where they opt in to include their data in the marketplace, and when corporations and/or third parties purchase for monetized user controlled access to their data. For example, the data may be managed within a self-directed and mobile computing environment. The illustrative embodiments allow users to determine how and when their data is shared, and monetized eliminating guesswork used by most major search marketing companies allowing each platform based user to determine, approve, and control access to 3^{rd} party desired access to their personal, profile and commercial and consumer marketing data.

In one embodiment, the asset of data is created by the opt-in submission of a user's social network profile(s), website utilization profiles, or generic/customized profile, and the associated data. The platform may be further used to secure a contract controlling all rights to any revenue streams or other monetization associated with the data asset (e.g., any sale, sharing, or monetization of the user profile for a third party, site, or advertiser). By opting into the program, the user is providing their profile and perfecting the profile to match their actual daily living and purchases of products and services. As a result, the illustrative embodiments put the user in full control of the use and monetization of their data while avoiding the erroneous or inaccurate use of information inherent in currently available blind or behavioral targeted advertising programs and systems. The illustrative embodiments improve known third-party unauthorized or non-monetized use of incomplete or inaccurate user data and enables the ability to provide an accurate user verified profile that creates a blockchain based method for user profile based monetized data streams. The platform provides numerous user benefits. Additionally, third parties gain the added advantage of better consumer profiling and targeting through the use of user profile confirmed and continually verified data.

The illustrative embodiments may enable the user to track utilization and monetization of their data and data profile in a more transparent fashion. As a result, the user may be able to access and track dividends, revenue sharing, price appreciation, or other forms of asset monetization. For example, a value-based reward system tracked utilizing blockchain may be implemented. Smart contracts may be utilized with the blockchain to ensure proper documentation, utilization and monetization of the data for contract and data verification purposes. The secured token generation process of the user data/profile provides proof of ownership to the user and ensures contract conditions are written into the smart contract code within the blockchain structure. The blockchain records maintain and track the creation, issuance, management, and monetization of each contract and token creation and contract data throughout the lifetime of the user's involvement and ownership of their data. In one embodiment, a user may be prompted, incentivized, and rewarded with additional tokens for keeping their data/profile updated as well as for additional participation in surveys, watch a video, verify, a purchase, advertisement studies, product marketing, expanded data provisioning, and questionnaires.

The user may be incentivized to provide additional data, such as pictures, audio content, videos, location (e.g., real-time, GPS, beacon, triangulation, delayed for safety, historical, etc.), Internet protocol address, identification of friends from each social network, sharing access to third-party applications, search data, views, likes, shares, comments, and so forth. As a result, the user may specify advertisement preferences that are associated with their demographics, opinions, behaviors, beliefs, social structure, purchase plans, and real-world desires. The user data that is recorded and stored may reside permanently on the blockchain, but typically only has a three-year lifecycle to be relevant. Thus, the user is incentivized to maintain, share, and update their data and associated profiles to ensure maximized monetization of the profile data.

The data profile may be singular to a user or may be expanded to include deeper insights into a family, group of friends, employees, or other affiliated or associated groups. For example, a family circle profile may include an opt in for parents, children, grandparents, uncles, cousins, neighbors, family friends, and so forth. The data profile may be shared as a family asset between a partner, spouse, and children allowing the family data to be managed and monetized as a single asset. As a result, advertisers and others may get deeper insights into each participating user. The illustrative embodiments manage the data collection, pricing, reconciliation, verification, payments, or so forth. Advertisers may be able to identify commercial and consumer data that is relevant to their campaign in order to provide direct incentives and/or monetization for users who provide specific advertiser-based insights.

The illustrative embodiments may also allow user to transfer or donate the revenue or value generated for a charitable deduction or associated tax deduction. Each of the described data components is 100% opt in with users being rewarded for sharing specific data points that are desirable to advertisers or other third parties. For example, users may opt-out of specific data points that the do not wish to share with advertisers or may choose advertisers that they wish to deny access to their profile data. The data captured by the illustrative embodiments may be consolidated and purchased by advertisers who provide incentives, rewards, or donations in exchange for access to users and focus group data used for the mining of advertiser-based user insights, analytics, marketing, and advertisement targeting.

The illustrative embodiments may also be utilized to create a data index that catalogs user profiles, data sets, and data transactions. Advertisers may then select a pricing structure for each type of data profile component that is desirable to advertisers thereby creating a virtual market for advertisers to purchase real time user data. The changing values and the future value of the data may be tracked over time for specific user profiles, commercial and consumer groups, corporations, services, and other similar data pools based on their value to advertisers, data vendors and corporations. The use of security tokens tied to user profiles creates a mechanism to control and value profile, commercial and consumer and corporate data as a marketable asset that gives greater validity to commercial uses of blockchain technologies and the security token market.

Security tokens may be generated by the platform and may utilize custom, established or traditional blockchain based token mining processes (but is not limited to these methods), for creating the value attributed to each generated token. The token value may be generated from revenue or other incentives provided by advertisers and others that provide the tokenized value for each token. The tokens may be generated and exchanged for actual currency, preferred stock options, stock warrants, bonds, exchange traded fund (ETF) shares, cryptic or, initial coin offerings (ICO), gift cards, vouchers, and other forms of compensation.

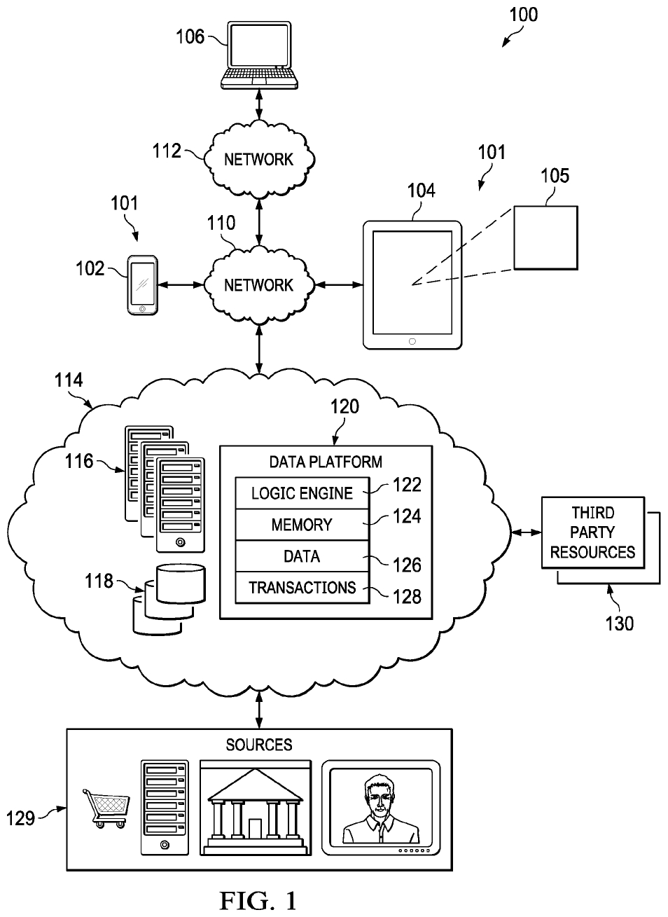

FIG. 1 is a pictorial representation of a system 100 for managing user data in accordance with an illustrative embodiment. In one embodiment, the system 100 of FIG. 1 may include any number of devices 101, networks, components, software, hardware, and so forth. In one example, the system 100 may include a smart phone 102, a tablet 104 displaying graphical user interface 105, a laptop 106 (altogether devices 101), a network 110, a network 112, a cloud system 114, servers 116, databases 118, a data platform 120 including at least a logic engine 122, a memory 124, data 126, and transactions 128. The cloud system 114 may further communicate with sources 129 and third-party resources 130.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 100 may be utilized by any number of users, organizations, or providers to aggregate, manage, review, analyze, process, tokenize, distribute, advertise, market, display, and/or monetize data 126 (e.g., persona/consumer, commercial, etc.). For example, the data 126 may be utilized in marketing or advertisements for goods or services. In one embodiment, the goods and services represent any number of items, content, products, or services sold by a business, entity, organization, or entity. In one embodiment, the system 100 may utilize any number of secure identifiers (e.g., passwords, pin numbers, certificates, etc.), secure channels, connections, or links, virtual private networks, biometrics, or so forth to upload, manage, and secure the data 126, generate tokens, and perform applicable transactions. As noted, the system 100 may be a blockchain system that utilizes a digital ledger to track transactions involving the data 126 or utilization thereof. For example, the digital ledger may store the transaction details, information, and data. The devices 101 are representative of multiple devices that may be utilized by businesses or commercial and consumers. The devices 101 utilize any number of applications, browsers, gateways, bridges, or interfaces to communicate with the cloud system 114, platform 120, and/or associated components.

The data 126 may include a number of different data types. The data 126 may include demographic data, commercial and consumer data, family and health data, property data, interests and activity data, and other applicable types of data. Demographic data may be a combination of static and influx data points that include age, gender, occupation, marital status, education/education level, income level, religion, birthday, family size, and so forth. Demographic data, although mostly static, is commonly quite important to marketers and other interested parties. Commercial and consumer data may include websites visited, purchase plans, purchases, brand affinity, cars, clothes, travel, and other information applicable to users, clients, customers, groups, or so forth. The family and health data may include permanent or long-lasting data elements which may be helpful for predicting future purchases and include information related to personal, family, health, commercial and consumer purchases, commercial and consumer intentions, and medical conditions, such as child care, diapers, diabetes, incontinence, rental information, and so forth. The family and health data has a large potential for cross marketing of data. Property data may include information regarding ownership, rentals/renters, address, for sale, occupants, pool, and vehicle ownership. This data may be treated and value as static data (even though changes are likely and expected). The interests and activity data may include data regarding hobbies, general interests, product and brand preferences, and other applicable influx data.

The wireless device 102, tablet 104, and laptop 106 are examples of common devices that may be utilized to receive and manage data 126 and perform transactions related thereto. Other examples of devices 101 may include e-readers, cameras, video cameras, audio systems, gaming devices, vehicle systems, kiosks, point of sale systems, televisions, smart displays, monitors, entertainment devices, medical devices, virtual reality/augmented reality systems, or so forth. The devices 101 may communicate wirelessly or through any number of fixed/hardwired connections, networks, signals, protocols, formats, or so forth. In one embodiment, the smart phone 102 is a cell phone that communicates with the network 110 through a 5G connection. The laptop 106 may communicate with the network 112 through an Ethernet, Wi-Fi connection, or other wired or wireless connection.

The data 126 may be collected and sourced from any number of online and real-world sources including, but not limited to, website traffic and cookie-based analytics, social media, social profile, and application data, point of sale, purchase, and transaction history, loyalty programs and coupons, location-based email list for mailers, surveys and questionnaires, and other applicable sources.

These same data collection sources may be utilized to perform valuation of specific data points. In one embodiment, the data 126 may be captured through website traffic and tracking cookie-based analytics. Website traffic is the most common form of marketable data collection and may provide numerous insights and methods to inform and populate a commercial and consumer web profile. This type of data collection may provide countless insights into search engine rank, time spent on a website, page views, clicks, conversions, and so forth which all contribute to site and traffic value. Website and cookie tracking may have static, perennial, and influx data points. The value of each data point may be tracked and measured within a data value index and data derivatives marketplace.

The data 126 may be captured through social media and applications. Social media data may be utilized to provide real-time polls, likes and dislikes, feedback, preferences for media content, site traffic, and numerous other commercial and consumer data. Any number of mobile, computing, personal assistant (e.g., Siri, Alexa, Cortana, Google, etc.), or other applications may be utilized. Social media data may be measured and valued as influx data within the data valuation index and data valuation marketplace.

The data 126 may be captured through point of sale, transaction, and purchase history. The point of sale data may be inherent in most business functions, but may not have been fully monetized in the past. Customers, commercial and consumers, and clients may be comfortable with sharing the specific data points associated with point-of-sale transactions due to est. practices. The point-of-sale transactions may include extensive data, including, but not limited to, name, address, age, gender, brand preference, brand category, product affinity, spending levels, order history, inventory, restock data, purchase demographics, and so forth. Point-of-sale and transaction history data may have static, perennial, and influx data points with the value of each data point being tracked and measured within the data valuation index and the data derivatives marketplace.

The data 126 may also include loyalty programs, memberships, and coupons. Large amounts of commercial and consumer data may be gathered by offering customers, clients, and others incentives for using loyalty cards and coupons. Loyalty programs that connect through a point-of-sale system may provide additional layers of commercial and consumer data collection. The loyalty programs, memberships, and coupons may include static, perennial, and influx data points that are similarly tracked and measured within the data valuation index and the data derivatives marketplace.

The data 126 may also include location-based communications. An example of static and perennial data points that may be collected include a standard web form, email request form, booth, proximity beacons, and so forth. The location-based communications may capture data, such as email, commercial and consumer addresses, phone numbers, and so forth. Location based data may be valued as static or perennial data in the valuation index and data valuation marketplace.

The data 126 may also include surveys and questionnaires. Responses to surveys and questionnaires may be one of the best ways to gather and inform influx commercial and consumer data points. The ability to gather real-world commercial and consumer insights may help complete or round out a user profile. The surveys and questionnaires may be performed digitally (e.g., websites, extensions, programs, applications, browsers, texting, or manually (e.g., audibly, on paper, etc.). Responses to surveys and questionnaires may help achieve saturation of commercial and consumer datapoints for profiles. The survey and questionnaires may be categorized as influx data and may be measured, valued, and traded through a data valuation index and data valuation marketplace.

The cloud system 114 may aggregate, manage, analyze, and process data 126 and tokens across the Internet and any number of networks, sources 129, and third-party resources 130. For example, the networks 110, 112, 114 may represent any number of public, private, virtual, specialty, or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks, 110, 112, 114 of the system 100 may represent a single communication service provider or multiple communications services providers.

The sources 129 may represent any number of web servers, distribution services (e.g., text, email, video, etc.), media servers, platforms, distribution devices, or so forth. In one embodiment, the sources 129 may represent the businesses that purchase, license, or utilize the data 126, such as advertising or marketing goods and services utilizing the system 100. In one embodiment, the cloud system 114 (or alternatively the cloud network) including the data platform 120 is specially configured to perform the illustrative embodiments.

The cloud system 114 or network represents a cloud computing environment and network utilized to aggregate, process, manage, sell, monetize, and distribute data 126 and support the associated transactions and utilization. The cloud system 114 may implement a blockchain system for managing the data 126. The cloud system 114 allows goods and services from multiple businesses, users, managers, or service providers to be centralized. In addition, the cloud system 114 may remotely manage configuration, software, and computation resources for the devices of the system 100, such as devices 101. The cloud system 114 may prevent unauthorized access to data 126, tools, and resources stored in the servers 116, databases 118, and any number of associated secured connections, virtual resources, modules, applications, components, devices, or so forth. In addition, a user may more quickly upload, aggregate, process, manage, and distribute data 126 (e.g., profiles, updates, surveys, content, etc.) where authorized, utilizing the cloud resources of the cloud system 114 and data platform 120. In addition, the cloud system 114 facilitates distribution of data 126 for one or more tax benefits, charitable causes, transactions, or other implementations. The cloud system 114 allows the overall system 100 to be scalable for quickly adding and removing users, businesses, authorized sellers, cause-based information, analysis modules, distributors, valuation logic, algorithms, moderators, programs, scripts, filters, transaction processes, distribution partners, or other users, devices, processes, or resources. Communications with the cloud system 114 may utilize encryption, secured tokens, secure tunnels, handshakes, secure identifiers (e.g., passwords, pins, keys, scripts, biometrics, etc.), firewalls, digital ledgers, specialized software modules, or other data security systems and methodologies as are known in the art. The platform is used as a vault for personal, user profile, corporate data and data pools that secure the data from standard internet profiling and targeting methods through the use of VPN's, secure networks, firewalls and internet data encryption methodologies that ensure the vaulted data cannot be accessed without user profile permission. The cryptographic tokens that are generated in exchange for data storage and access represent a set of rules, encoded in a smart contract that ties the token contract to specific requirements to grant or deny access to each user or data point contained in a data profile.

Although not shown, the cloud system 114 may include any number of load balancers. The load balancer is one or more devices configured to distribute the workload of processing the uploaded data 126 as well as applicable transactions to optimize resource utilization, throughput, and minimize response time and overload. For example, the load balancer may represent a multilayer switch, database load balancer, or a domain name system server. The load balancer may facilitate communications and functionality (e.g. database queries, read requests, write requests, command communications, stream processing, etc.) between the devices 101 and the cloud system 114. For example, the cloud system 114 may offload verification of users that seek to be added to the system 100 along with applicable data 126 and information. Load balancing may be performed between automatic systems and devices as well as individual users. Other intelligent network devices may also be utilized within the cloud system 114.

The servers 116 and databases 118 may represent a portion of the data platform 120. In one embodiment, the servers 116 may include a web server 117 utilized to provide a website, mobile applications, and user interface (e.g., user interface 107) for interfacing with numerous users. Information received by the web server 117 may be managed by the data platform 120 managing the servers 116 and associated databases 118. For example, the web server 117 may communicate with the database 118 to respond to read and write requests. For example, the servers 116 may include one or more servers dedicated to implementing and recording blockchain transactions and communications involving the data 126. For example, the databases 118 may store a digital ledger for updating information relating to the user's data 126 as well as utilization of that data 126. The databases 118 may utilize any number of database architectures and database management systems (DBMS) as are known in the art. The databases 118 may store the content associated with each user/commercial and consumer/purchaser which may specify an address, name, age, demographics, interests, family/friend information, biometric identifiers, payment information, permissions, settings, location, cause preferences, cause restrictions, and so forth. Any number of secure identifiers, such as tones, QR codes, serial numbers, or so forth may be utilized to ensure that content, personal, or transaction information is not improperly shared or accessed.

The user interface 105 may be made available through the various devices 101 of the system 100. In one embodiment, the user interface 105 represents a graphical user interface, audio interface, or other interface that may be utilized to manage data and information. For example, the user may enter or update associated data utilizing the user interface 105 (e.g., browser or application on a mobile device). The user interface 105 may be presented based on execution of one or more applications, browsers, kernels, modules, scripts, operating systems, or specialized software that is executed by one of the respective devices 101. The user interface may display current and historical data as well as trends. The user interface 105 may be utilized to set the user preferences, parameters, and configurations of the devices 101 as well as upload and manage the data, content, and implementation preferences sent to the cloud system 114.

In one embodiment, the system 100 or the cloud system 114 may also include the data platform 120 which is one or more devices utilized to enable, initiate, generate, aggregate, analyze, process, and manage data 126, transactions 128, and so forth with one or more communications or computing devices. The data platform 120 may include one or more devices networked to manage the cloud network and system 114. For example, the data platform 120 may include any number of servers, routers, switches, or advanced intelligent network devices. For example, the data platform 120 may represent one or more web servers that performs the processes and methods herein described.

In one embodiment, the logic engine 122 is the logic that controls various algorithms, programs, hardware, and software that interact to receive, aggregate, analyze, rank, process, score, communicate, and distribute data, content, transactions, alerts, reports, messages, or so forth. The logic engine 122 may utilize any number of thresholds, parameters, criteria, algorithms, instructions, or feedback to interact with users and interested parties and to perform other automated processes. The logic engine 122 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data 126, transactions 128, instructions, and information. In one embodiment, the memory 124 and logic engine 122 may be integrated. The memory 124 may use any type of volatile or non-volatile storage techniques and mediums. In one embodiment, the memory 124 may store a digital ledger and tokens for implementing blockchain processes.

In one embodiment, the cloud system 114 or the data platform 120 may coordinate the methods and processes described herein as well as software synchronization, communication, and processes. The third-party resources 130 may represent any number of human or electronic resources utilized by the cloud system 114 including, but not limited to, businesses, entities, organizations, individuals, government databases, private databases, web servers, research services, and so forth. For example, the third-party resources 130 may represent advertisement agencies, marketers, e-commerce companies, and others that pay for rights to use the data 126.

In one embodiment, the data platform 120 may implement a blockchain ledger, manager, or technology. In another embodiment, the blockchain ledger may be accessible through sources 129. Any number of existing blockchain companies or providers may be utilized (Aeternity, Ethereum, Bitcoin, Dfinity, ContentKid, Blockphase, Chain of Things, Flowchain, Decissio, Cognate, SkyHive, Safe, etc.).

The blockchain is utilized as a way to store and communicate the data 126 along with transactions 128. The blockchain may utilized one or more distinct ledgers for different entities, services providers, types of data, users, or so forth. For example, each new user with data received by the data platform 120 is assigned a token or other secure identifier. In one embodiment, the digital tokens may be managed utilizing a key that allows the user or controlling party to access the ledger. In one example, the tokens may be controlled by the user or control may be reassigned. The blockchain may cross-reference updates to the data 126 with the original record for the data platform 120 to ensure proper maintenance, control, licensing, management, and transactions. In one example, different licensing tiers, pricing algorithms, license verification, cause information, and payments are combined to create a unique platform. The illustrative embodiments provide a system 100, cloud system 114, and data platform 120 for compiling businesses that support causes and documenting commercial and consumer transactions that support those causes.

The blockchain may also utilize any number of payment systems (e.g., PayPal, Venmo, Dwolla, Square, wire transfers, credit cards, Quicken, etc.) to fund a tokenized advertising or marketing campaign and to receive money and distribute payments to the applicable party. In one embodiment, the data platform 120 may receive a small fee or percentage per transaction, data uploaded/updated, data purchased, shared, or licensed, purchased item, browsing session, or so forth. In one embodiment, the data platform 120 may be utilized to verify users and advertisers (as well as other users/entities that utilize the data platform 120) and associated data 126 and transactions 128 associated with the data 126.

The third-party resources 130 may represent any number of electronic or other resources that may be accessed to perform the processes herein described. For example, the third-party resources 130 may represent government, private, and charitable servers, databases, websites, services, and so forth for verifying tax deductible or charitable donations of data. In another example, auditors may verify information provided by businesses with regard to the causes 128 associated with the businesses themselves or their associated data 126.

Many segments of the global economy are data rich and include the business operations and individuals involved in the fields of retail, business, agriculture, non-profit and for profit organizations, healthcare, media, government, and finance that all create data that may be captured, tokenized, and monetized by various embodiments as described herein.

In one embodiment the sources 129 may represent alumni, specialty clubs, and affinity groups or organizations that may participate to share or curate their data including user data and profiles. For example, the data may pertain to segmented groups with shared interests or activities that may be monetized. The usage of donations and the delivery of data valuations may be utilized for tax reductions. Various data and venue owners that access the data platform 120 may legally extract and tokenize the data 128 for use in the exchange provided by the system 100 by identifying and tracking data utilizing automatic data extraction tools.

In one embodiment, a user or commercial and consumer group represented by a user of the devices 101 or the sources 129 may elect and receive permission to collect observational data collected from secure and authorized systems to achieve access to partial or complete data from the sources 129 (e.g., professional drivers, human resources, prison records, property values, real estate sales, retail sales, retail prices, commerce, waste stream data, etc.).

The logic engine 122 may perform valuation of the data 126. For example, all the of the global resources and information, such as the price paid for data of all types and transactional data (e.g., micro transactions, cost per thousand, bulk sales, etc.) may be utilized to perform valuations. The logic engine 122 may also track and value accrual, sales, or transfers of data 126 between one or more companies to provide valuations as included in corporate transactions (e.g., acquisitions, mergers, stock purchases, buyouts, etc.). Companies, entities, or other organizations may also value their commercial and consumer data 126 and tie that value to their market capitalization providing public companies the ability to measure and place a valuation on corporate data reserves.

The logic engine 122 may process data feeds received to capture data 126 from companies that the value of commercial and consumer advertisements within the operations of Internet/data, television, radio, print, outdoor, and other advertising for automatic valuations. For example, the logic engine 122 may access sources 128 including data exchanges, markets, consultants, management systems, and so forth to determine the value of the data. For example, current and historical values for data may be determined and utilized in real-time. The data may be valued in a secondary data valuation and futures market exchange or the data platform 120 itself may be utilized in a platform-based valuation index and data exchange, similar to stock exchanges, except for the guided by global price guidelines, rules, and laws for the data industry. The data platform 120 may also make determinations of data utilization and valuation in the dark web to mitigate problems and provide additional potential for platform-based sales and services. In one embodiment, anonymous sources within an opt in system may be utilized to map data values and specific data requests posted and exchanged in the dark web along with the associated value to determine flow and monetization for minimizing potential risks.

The illustrative embodiments may also support third-party valuations of data. The validations may be performed by auditing groups, commissions, industry groups, or other professionals/entities. In one embodiment, the sources 129 may determine or verify data valuations. The data that is improved and/or validated may increase in value. Any number of artificial intelligence or computerized processes may be utilized to validate data. The sources 129 may also aggregate data 126 into portfolios. Portfolios of data may be managed, transferred, and otherwise utilized for the benefit of the data owners.

Data valuation may also be associated with geographic locations. The association of data with a location may be performed utilizing GPS data, location-based services, beacons, wireless triangulation, location-based services, tracking programs, interfaces, connections, protocols, video surveillance, or so forth. For example, by looking at the service locations, layouts, planograms, foot traffic of the venue and interpreting a data capture capability may help determine whether resources are justified or not.

The data platform 120 may provide any owner of data 126 an effective way to value the data. By automatically identifying the drivers of global data transaction valuations, the different stockpiles or silos of data ownership may be understood along with their corresponding value utilizing the data platform 120. The data 126 including groups of data may be utilized to perform fundraising, crowdfunding, or charitable work for a user or group. For example, a school fundraiser may allow people to donate their data 126 temporarily or indefinitely. In another example, an advertiser of a product line may partner with a fundraising group to provide marketing groups that participate in surveys or studies to like-minded commercial and consumer groups, mine data-based insights, such as demographic, political, family, business network, social network, religion, tastes, opinions, past and planned purchases, and other types of marketing-based questions. The donations or incentives may be determined by the size of the group who participate or based on other advertiser and profile ownership parameters.

In one embodiment, the logic engine 122 may utilize artificial intelligence. The artificial intelligence may be utilized to enhance data 126 and increase its value. For example, artificial intelligence may be utilized to review, authenticate, and validate data that is received by the system 100. The artificial intelligence of the logic engine 122 may be utilized to ensure that the data 126 is improved, accurately analyzed, and value increased. For example, it is expected that data and the associated tokens that are validated utilizing artificial intelligence may be given a premium value by both buyers and sellers.

The data 126 may also represent tracking of both real property or intellectual property that may be assigned, managed, licensed, litigated, gifted, transferred, and so forth. For example, the data 126 may be transferred by wills, trusts, end-of-life conveyances, inheritances, liquidations, distributions, last wishes, designated beneficiaries, charitable donations, and other mechanisms used for real and intellectual property. Valuation of a “data estate” may also be performed by the data platform 120 as one of many potential valuations performed as part of the transactions 128. As a result, the data is treated like any number of valuable assets.

In another embodiment, the devices 101 may include any number of sensors, appliances, and devices that utilize real time measurements and data collection to update the data 126. For example, a sensor network, wearables (e.g., watches, bands, implantable devices, etc.) and Internet of things (IOT) devices may gather user and behavioral data. The data platform 120 may also work in conjunction with hands-free data mining and measurement tools that tracks location, activity, and video-based marketing data (e.g., from GPS location, video from storefronts, beacon detection, proximity alerts, etc.) from any number of third-party sources. The user may be tracked through any number of environments, locations, and conditions. Beacons may be used for anonymous and specific data markers and commands. For example, a beacon may be utilized to generate a commercial and consumer interaction in which the commercial and consumer is asked to connect via social media to followers for the purpose of sharing and creating data 126 regarding a specified product or service.

The illustrative embodiments may allow data management to be outsourced from any number of users, businesses, or organizations to the system 100 and/or the data platform 120. For example, the data platform 120 may manage bulk data for a small business without the resources to fully analyze and monetize the data 126. The data 126 and the associated tokens may also be leveraged in times of crisis to obtain loans, provide donations, or otherwise benefit the users.

In one embodiment, the data platform 120 may extract data from third-party platforms by opting in and providing user credentials to various applications (e.g., Facebook, Twitter, Reddit, News Sites, Amazon, Google, etc.) the data platform 120 may extract data from the sources 129.

The data platform 120 may capture known data, behavioral information, psychological, mood data, and other intangible data. The data 126 may be validated through artificial intelligence, machine learning, human analysts/consultants, or other automated or manual processes. For example, the system may be utilized to document participation and track results and side effects from a medical trial. The effective use of the data 126 may be rated for individuals, companies, facilities, or others. Data waste and data proficiencies may be managed through the data platform 120. For example, the data platform 120 may be utilized to determine counterfeits of products, brands through unique product mark documentation and identification via the blockchain.

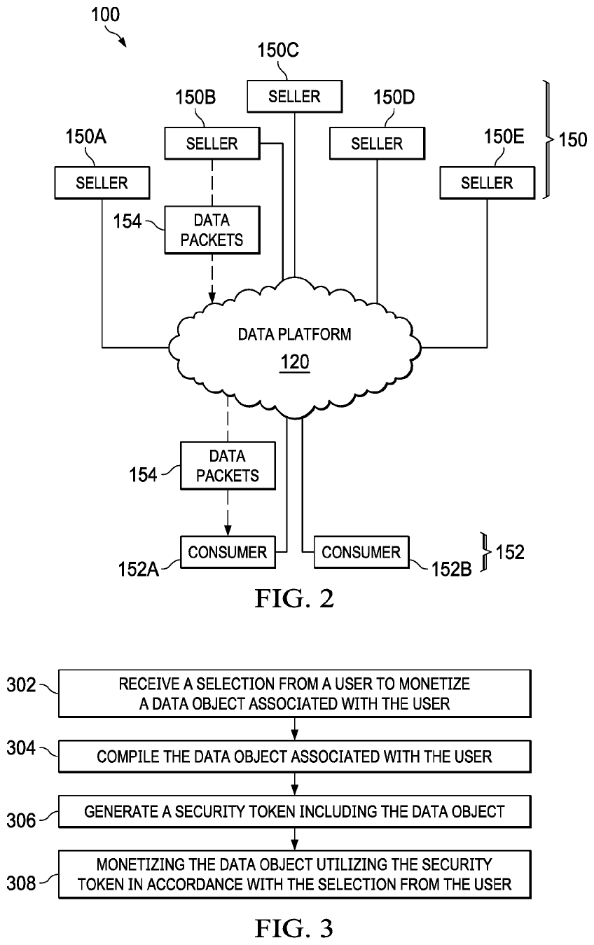

FIG. 2 further illustrates portions of the system 100 of FIG. 1 in accordance with an illustrative embodiment. As shown the advertisers 150A-E (jointly advertisers 150) may represent the sources 129 of FIG. 1. The sellers 150 may represent any number of advertisers, marketers, businesses, retailers, service providers, individuals, organizations, entities, or so forth referred to as sellers 150 or businesses for purposes of simplicity. The commercial and consumers 152A, 152B (jointly commercial and consumers 152) represent any number of users, commercial and consumers, groups, or individuals that have data 154 that they are willing to allow the sellers 150 to access through the data platform 120. In one embodiment, the data platform 120 may represent all or portions of the system 100 of

FIG. 1 (including the cloud system 114, servers 116, databases 118, etc.).

The consumers 152 may actively or passively incentivized or prompted to upload data 154 to the data platform 120. The data platform 120 may also receive amended, updated, or additional data 154 for the consumers 152 at any time as described herein. The consumers 152 may have an agreement for the distribution of the data 154 to the sellers 150 or other interest parties. The agreement or contract may specify how, when, and what portions of the data 154 may be used as well as the associated compensation terms. The agreement may specify that the data 154 may be purchased, licensed, rented, leased, or otherwise managed by the data platform 120 for the mutual benefit of the consumers 152 and the sellers 150. For example, the consumer 152A may elect to receive a one-time payment of tokens for data 154 provided to the data platform 120 for seller 150A. In another example, the consumer 152B may elect to license use of their data 154 such that they are compensated utilizing a digital currency (or hard currency) for each access of or utilization of their data 154 by the sellers 150.

The data platform 120 performs valuation of the data 154 based on information from any number of sources including current rates, contracts, indices, exchanges, and other applicable information. For example, current targeted advertisement rates may be utilized to value the data. The tokens paid to the consumers 152 in exchange for the data 154 may vary based on the volume, quantity, verification, and types of information included in the data 154. The data platform 120 normalizes data monetization for the consumers 152 and sellers 150. Compensation performed by the data platform 120 may be performed utilizing known cryptocurrency and may fund the tokenization through traditional funding utilizing digital currencies or existing currencies. In one embodiment, blockchain-based currencies may be utilized to compensate the consumers 152. Full tokens or partial tokens may be utilized to most accurately represent the values being exchanged. There may be a predefined number of tokens available thereby allowing early adopters of the system 100 to earn more over time. For example, in response to the consumer 152A selling the data 154 to the data platform 120 or the seller 150B, the consumer or commercial user may be compensated with tokens (e.g., Bitcoin, Ethereum, proprietary tokens, etc.). All or portions of the data 154 may be involved in a transaction. For example, the data 154 may include numerous components relating to all aspects of the life, work, hobbies, entertainment, studies, politics, health, family, commercial and consumer habits, for the consumer 152B. The seller 150D may only license rights to temporarily (e.g., for one year) access the commercial and consumer habits of the consumer 152B existing and updated in real-time. The exchange for the tokens may include a pointer to a secure storage or vault accessed through the data platform 120. The pointer may be an encryption key, access information, unique identifier, or other security information for accessing the data 154 associated with the user. In another embodiment, security tokens used for the blockchain may also be embedded with the data 154. The tokens granted through the data platform 120 may vary in value, may be fixed, or may act similar to other monetary instruments (e.g., stocks, bonds, certificates of deposit, etc.) for a specified original value of the data 154.

The data platform 120, sellers 150, or consumers 152 may keep and maintain digital ledgers that track the transactions within the system 100 to verify and authenticate the data and associated transactions. The sellers 150 may utilize the data 154 to advertise, sell, or market goods, services, products, perform market research, generate analytics, or so forth. As previously noted, the data platform 120 may also represent one or more processing, analysis, blockchain, or distribution centers, systems, devices, facilities, or so forth. The sellers 150 and consumers 152 may represent any number of individuals or groups (e.g., hundreds, thousands, millions, etc.).

As noted, the sellers 150 may send or distribute goods and services 154 through the cloud system or directly to the consumers 152. In one embodiment, the seller 150B may distribute goods and services 154 to the consumer 152A through the data platform 120. The data platform 120 may perform distribution of the goods and services 154. For example, the data platform 120 may include any number of physical storages, digital storage, warehousing, and distribution systems, facilities, professionals, employees, contractors, electronics, and so forth.

FIG. 3 is a flowchart of a process for monetizing data in accordance with an illustrative embodiment. The process of FIGS. 3-6 may be performed by a platform, device, server, or other equipment in accordance with illustrative embodiments. All or portions of the process of FIGS. 3-6 and 10 may be performed automatically. The process of FIG. 3 may be implemented by a system or platform, such as the system 100, data platform 120, or devices 101 of FIG. 1 referred to generically herein as the platform. The steps of FIGS. 3-6 and 10 may be combined and utilized in any order.

In one embodiment, the process may begin by receiving a selection from a user to monetize a data object associated with the user (step 302). The selection may be an opt-in selection made by the user. For example, the selection may involve the acceptance of financial or legal language utilizing a graphical user interface presented utilizing a web interface, mobile application, or so forth. The selection may be to monetize the data for the user himself/herself, a charity or cause, or for a third-party individual or group. In one embodiment, a profile associated with the platform may specify the types of data that may be captured as well as how the data object(s) may be utilized. For example, a platform profile may include any number of settings, configurations, parameters, selections, releases, authorizations, verification requirements, or other information and data that controls how the user's data is utilized in accordance with the illustrative embodiments. The user referenced in step 402 may also refer to a group of people, entity, organization, associated persons, or so forth. The data object may also be referred to as personal data, commercial and consumer data, private data, monetized data, authorized data, and marketing data.

Next, the platform compiles the data object associated with the user (step 304). As noted, the data object may include profiles, user selections, user input, sensory data, or other information and data actively or passively gathered about the user as objects attributes, elements, fields, sets, pools, or other configurations of data. The profiles may be applicable to websites, mobile applications/programs, services, devices (e.g., smart phones, exercise equipment, vehicles, smart furniture, wearables, hearables, etc.), or so forth. The data may be acquired over time based on the input, selections, activity, and other actions of the user. The data object may also be acquired in real-time. The data object may include any number of categories, fields, or values that may be expanded over time to capture relevant information about the user in any number of fields, categories (e.g., amusement, work, school, sports, media, etc.), experiences and so forth. The data may include public, private, customized, and proprietary data permitted by the user.

Next, the platform generates a security token including the data object (step 306). In one embodiment, the security token is generated utilizing blockchain. The security token may include all or portions of the data object associated with the user. For example, one security token may incorporate information relating to the health, exercise, and nutrition of the user. In one embodiment, the security token is a form of digital currency that may be spent, exchanged, granted, transferred, or utilized for any number of purposes. For example, the user may be granted multiple tokens at once, over time, or is otherwise allocated based on the value associated with the data object in the security token and its utilization.

Next, the platform monetizes the data object utilizing the security token in accordance with the selection from the user (step 308). As previously noted, the data may be monetized through sale, license, royalty, rent, lease, exchange, pay-per-use, and other forms of commercialization. Any number of security tokens, digital currencies, or real currencies may be used in whole or partial values.

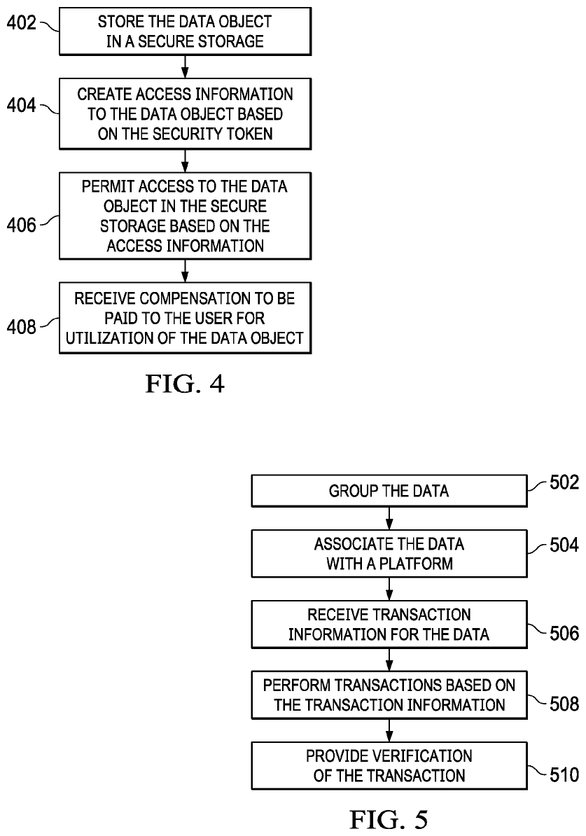

FIG. 4 is a flowchart of a process for managing compensation for data in accordance with an illustrative embodiment. FIG. 4 may be implemented with or as a separate portion of FIG. 3. In one embodiment, the process of FIG. 4 may begin by storing the data object in a secure storage (step 402). The secure storage may represent a vault, archive, secured server farm, or other secure mechanisms or locations. The secure storage may represent a secure server that is integrated with the user's network, system, architecture, platforms, or so forth.

Next, the system creates access information to the data object based on the security token (step 404). The access information may be utilized to access the data associated with a user. For example, a marketing or sales company may utilize the information from a user that has received compensation for their data.

Next, the system permits access to the data object in the secure storage based on the access information (step 406). The access may be granted in response to receiving the access information from the accessing party (e.g., business, processor, etc.). The data object may be communicated utilizing any number of secured channels, networks, tunnels, or so forth. In one embodiment, applications executed by the data platform and a device of the accessing party may be utilized to securely exchange data.

Next, the system receives compensation to be paid the user for utilization of the data object (step 408). The compensation may represent any number of digital currencies (e.g., tokens), real currencies, rewards, exchanges, and so forth.

The illustrative embodiments may be utilized to perform transactions of the data in real-time, based on historical trends, or based on forward or futures contracts. The illustrative embodiments provide a system and method for data valuation, data management, and data governance for corporations, organizations, individuals, and data vendors to convert their corporate data into an asset that provides measurable and quantifiable passive revenue.

Many large and small corporate businesses, entities, organizations, and individuals have extensive databases of commercial and consumer data that are often underutilized or not monetized as a revenue stream. Entities that recognize and monetize the value of their corporate data often enjoy higher stock prices, larger market shares, and better profitability. The illustrative embodiments per vied a system and method for data valuation through the creation of a data value index and marketplace.

A data valuation index and data value marketplace may be desirable to middle-market and less capitalized companies who may be unable to generate significant amounts of commercial and consumer data like the well-known “big data” companies. The illustrative embodiments may be utilized to provide smaller entities systems, methods, and tools for hedging their data assets as well as measuring the potential value of their data assets in the future.

The illustrative embodiments allow for the creation of a data derivatives market and contracts based on underlying data assets. For example, a platform implementing this method makes sub- classifications for data and transactions relating to industry, geography, and other specific value level classifications. The creation of a data valuation marketplace may also allow companies to provide audits of data balance sheets and other data specific statements, much like traditional financial statement audits. The creation of data derivatives may also create a large marketplace for speculation in which traditional hedge funds, investors, and other investment managers may be able to trade in “data funds” similar to traditional securities and transactions. Via the platform data brokers, advertisers, speculators, and others are able to buy a data future-contract based on the speculation value of any specific datapoint on the data futures market. The improvement provided allows for data brokers to make informed wagers on the fluctuation in the value of data at any point in time. The data future contract is documented via the blockchain and the data is sold based on the platform based on the smart contract instruction. The data broker will make a profit if the contract is executed when the price of specific data point and the price point has risen for that data point since the contract was first initiated the contract is executed via the platform and the data is for a profit. In turn if the they execute or sell the contract when the price of the data has dropped then the contract will be executed at a loss.

In addition, the illustrative embodiments may be utilized to provide a fluctuating price point for pieces of data, groups of data, types of data, or so forth. As various data elements are continuously generated and updated the data assets may be factored for the purpose of creating data asset backed securities which may be traded like traditional securities, stocks, and assets. Data assets may include features which pay a weighted average interest rate based on the level of risk taken (e.g., similar to bonds). Riskier data assets may then in theory pay a higher rate of interest then less risky assets. The illustrative embodiments provide a system, method, and platform for providing historical prices and a data exchange for trading and otherwise transacting associated data. Est. prices for the underlying data classifications and assets may be important to create effective derivative contracts.

It is often understood that there are five known and understood core asset classes in addition to sub asset classes. The common asset classes may include shares/equities, bonds/fixed-interest stocks, property, commodities, and cash. Previously, data assets, such as corporate data, would be classified as an intangible asset that falls under the “property” asset class with several additional intangible asset valuation methodologies used to determine the true value of a data sort as an asset.

Any number of data valuation principles may be utilized in allowing data be to be viewed, valued, and utilized as an asset class. For example, Gartner Data Valuations principles may be utilized. These principles may include information is an actual asset, information has both potential and realized value, information's value can be quantified, information should be accounted for as an asset (internally), information's realized value should be maximized, information's value should be used to help budget IT and business initiatives, and information should be managed as an asset.

Referring again to FIG. 1, the cloud system 114 or data platform (alone or in combination) may be utilized to manage transactions 132. The transactions 132 may represent the sale, utilization, transfer, licensing, royalty, rent, lease, securitization, or other form of exchange. In one embodiment, the transaction may be a futures transaction 134. The futures transaction 134 is a legal agreement to buy or sell the data 126 at a predetermined price at a specified time in the future. The seller of the data futures (e.g., operator of the cloud system 114) takes on the obligation to provide the data at the expiration date. As noted, the data 126 may represent data associated with businesses, organizations, entities, States, countries, coalitions, individuals, families, groups, or so forth. The data 126 may be personally or commercially compiled and obtained. The futures contracts utilized for the futures transaction 134 may be standardized for quality and quantity to facilitate trading. In one embodiment, one of the sources 129 or third-party resources 130 may represent a future exchange or clearing house. The sources 129 may also include any number of parties that participate with the owner, operator, service provider, individual, or entity operating the cloud system. For example, hedgers, speculators, producers, purchasers, portfolio managers, traders, and others may benefit from the system 100 and cloud system 114. The futures transactions 134 may be available on or as indexes, commodities, and currencies.

FIG. 5 is a flowchart of a process for performing transactions in accordance with an illustrative embodiment. The process of FIG. 5 may be performed utilizing one or more portions of the system 100 (e.g., cloud system 114, data platform 120, etc.). The process of FIG. 5 may be implemented or integrated as part of the process or steps of FIG. 4. The system may represent a cloud system/platform. The various resources may be distributed or otherwise managed for numerous users. Prior to performing the process of FIG. 5, data may be received from one or more users (e.g., individuals/consumers, commercial, etc.) based on permissions, authorizations, or verifications.

The process may begin by grouping the data (step 502). The data may also be referred to as a data asset or data token. The data may be grouped based on business/entity/organization, profiles (e.g., sex, age, etc.), affiliations, self-selections, individuals, one or more criteria, parameters, profile elements, data points, or other applicable data or information. The data may be associated with any number of different groups. The data may be stored in one or more servers, databases, or systems. In one embodiment, the data may be grouped utilizing pointers, calls, addresses, identifiers, or other information as units, sets, collections, or so forth. For example, specialized hardware may store data associated with each user to ensure privacy and protection of the user. The hardware may be partitioned, protected, or otherwise secured.

Next, the system associates the data with a platform (step 504). The platform may be a platform authorized to perform data transactions. In some embodiments, multiple platforms may exist for simultaneous, concurrent, or sequential transactions that involve the data. In one embodiment, the platform may be part of the system. For example, the platform may be a data platform/trading platform for performing different types of transactions (e.g., sales, purchases, receipts, payments, etc.). Any number of market, limit, short, put, option, future, or other transactions may be utilized for the data.

Next, the system receives transaction information for the data (step 506). The transaction information may include the type and amount of data that is included in the transaction. The transaction information may also specify the price or compensation associated with the transaction (e.g., dollars, bitcoins, exchanged goods, trading information, etc.). The transaction information may also provide details including, but not limited to, the predetermined price (forward price), the delivery date when delivery and payment occur, the buyer (i.e., long position holder), the seller (i.e., short position holder), margin information, third-parties involved, and so forth. In one embodiment, the transaction information may include fields or data that is automatically provided or entered by one or more users. Other trading platforms, devices, or equipment may communicate with the system of FIG. 5.

Next, the system performs transactions based on the transaction information (step 508). The transaction is performed based on the transaction information provided during step 506. As noted, the transaction information may be determined automatically, based on specified user input, or based on a combination of automatically determined/generated information and manual information. The transaction information of step 506 may include user input specifying how, when, why, and where the transaction is to be implemented.

Next, the system provides verification of the transaction (step 510). The verification may include all of the details for the transaction as previously noted. The verification may be sent as an email, printed receipt, invoice, in-application message, text message, chat message, or other form of digital or physical message. The transaction may uniquely identify the transaction with one or more codes, digital fingerprints, or identifiers. The transaction verification may be utilized for tax purposes, business tracking/ledgers, profit/loss analysis, and any number of purposes.

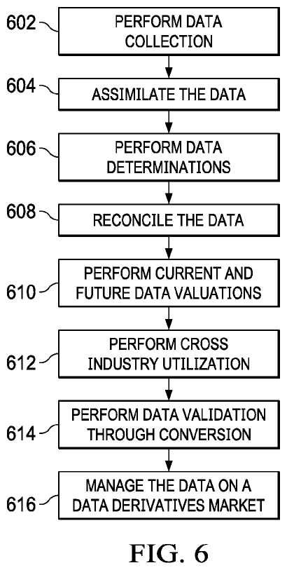

FIG. 6 is a flowchart of processing data for a data derivative market in accordance with an illustrative embodiment. The process of FIG. 6 may begin by performing data collection (step 602). The data may be collected in any number of ways. For example, the data may be collected utilizing web traffic and cookies, social media, applications, add-ins, and extensions, point-of-sale transactions and purchase histories, loyalty programs, memberships, and coupons, location-based communications, surveys and questionnaires, and other applicable data collection resources and inputs.

The online, digital, physical, and other data collection sources are limitless and may be utilized to generate a broad range of internal and external commercial and consumer insights. In one embodiment, the data collections true value may be measured by data source, source reliability, data volume, data reliability, data coverage, data functionality/multi-functionality, and end results. During step 602, data sources may be identified, located, and evaluated for cost, coverage, and quality.

Next, the system assimilates the data (step 604). In one embodiment, the system may enable cross-platform data measurements for current and future data valuations across various data collection pools and formats. The system may apply any number of mathematical processes, interpolation, modeling, optimization, machine learning, image analysis, and statistical methods to the data to perform assimilation and analyzation during step 604.

Next, the system performs data determinations (step 606). The data determinations may include performing data integration and categorization. Additional determinations may be made to key data points within the data structure to indicate whether the data point is considered influx or perennial data.

Next, the system reconciles the data (step 608). In one embodiment, the data may be integrated into a data marketplace managed by the system, analyzed, categorized, and valued for immediate actionable insights by identifying influx data with the limited data value window (e.g., advertising conversion).

Next, the system performs current and future data valuations. The platform-based data marketplace supported by the system may evaluate the data based on the reusability of each unique data point in a data pool. The reusability of the data may be a key indicator for measuring the size and scope of additional data utilization. Valuations may be performed based on real-time prices for data or similar data utilizing any number of parameters, conditions, factors, information, settings, providers, and so forth.

Next, the system performs cross industry utilization (step 612). During step 612 data may be further mined, identified, evaluated, and value based on the scope of cross industry utilization. The ability to identify utilizations of data across new industries or markets provides the ability to indicate the current value of the data pool (including new data) to speculate on the future value of the data pool based on newly identified markets for data utilizations and transactions. During step 612 the data may be monetized according to one or more agreements, contracts, laws, and monitored operation of the system.

Next, the system performs data validation through conversion (step 614). Various stated science methodologies may be utilized to measure, quantify, and value data which is then validated when the highest possible influx, perennial, and static data points are indicated. The combination of related or non-related data pools may facilitate completion of profile data points to create additional value. Reliable and consistent data as well as data generation may validate the utilization of the system providing stability for data generators, providers, and others.

Next, the system manages the data on a data derivatives market (step 616). The data derivatives market managed by the system may create a new tradable financial instrument for data. As a result, a large marketplace may be created in which investors, hedge funds, and investment managers may speculate and other ways trade and perform other transactions for data or data funds in the same manner as traditional financial securities.

In one embodiment, like FIG. 5, FIG. 6 may also be summarized as receiving data from sources (e.g., step 602), receiving data from the sources and grouping the data into a data asset (e.g., steps 604 and 606), associating the data asset with a data platform including one or more servers and databases (e.g., step 608), receiving transaction information for the data asset and performing one or more transactions for the data asset based on the transaction information and providing verification of the transaction for the data asset) (e.g., steps 610-616).

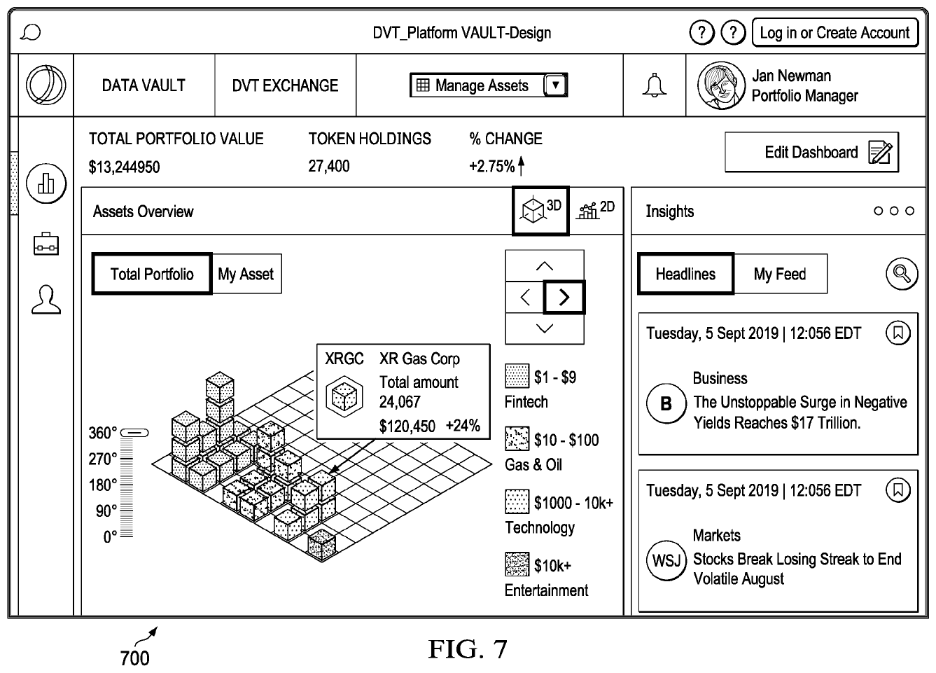

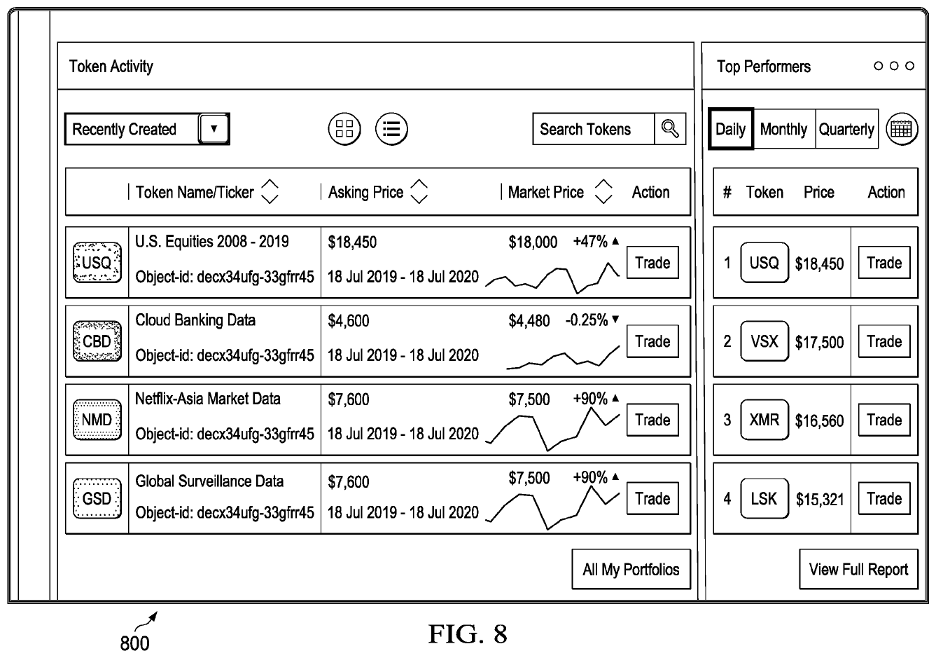

FIGS. 7 and 8 are pictorial representations of a user interface 700 and 800 in accordance with an illustrative embodiment. The user interface 700, 800 may represent different views of a single user interface or multiple user interfaces. The user interface 700, 800 may represent one or more of a web browser, mobile application, desktop application, set of instructions, or so forth. In one embodiment, the user interface 700, 800 provides a dashboard for viewing saved and available data as well as an exchange/platform for communicating data. For example, the user interface 700, 800 may be utilized to perform futures or actual transactions involving data. The data and information communicated through the user interface 700, 800 may be communicated visually (e.g., text, graphics, video, data, images, etc.), audibly, and/or tactilely. Any number of reports, graphics, and documents may be generated by the user interface 700, 800 to be sent (e.g., email, text, in-application message, hyperlink, etc.), exported, viewed, or utilized. The data and information may be displayed in two or three dimensions as selected by a user.

The user interface 700, 800 may allow a user (e.g., individual, company, entity, organization, etc.) to securely login to the platform. Any number of usernames, passwords, keys, encryption schemes, virtual private networks, standards, protocols, and so forth.

The user interface 700, 800 of the platform may allow the user to navigate available data assets. For example, the user interface 700, 800 may allow the user to search for specified users, types of data, data sets, data pools, and so forth. The data may be displayed using charts, graphics, images, text, and data in any number of formats. The current price, history, performance statistics (e.g., moving average, volume, open, close, highs—day, week, month(s), year, all, etc.) chart, profile, description, and other applicable information. The user may be able to perform transactions for the data during regular market hours or after hours setting. The user's tokens and associated value may be displayed by the user interface 700, 800. The user may purchase tokens and the associated data through the user interface 700, 800.

The user interface 700, 800 may also allow the user to view tokens held by the user. For example, the user may have sold her data or he company's data through an authorized transaction managed by the platform accessed through the user interface 700, 800. As previously noted, the data and tokens may represent personal data or commercial data. Different quantities of tokens may be granted based on the type of data. Alternatively, different types of tokens may be associated with different tokens. The user interface 700, 800 may be integrated with a traditional trading platform and interface with additional options for trading data futures or data assets.

The user interface 700, 800 may be utilized to set any number of alerts for notifying the user regarding changes in token valuation, value, change percentages, anomalies, new data, trades (e.g., real-time, limit, margin, shorts, options, futures, etc.), and so forth. The user interface 700, 800 may include provide details, such as token name/ticker, asking price, market price, action, headlines, feeds, The available information and data may be displayed by the user interface 700, 800 using any number of time periods (e.g., daily, monthly, quarterly, yearly, custom periods, etc.).

The user interface 700, 800 may also display information and details regarding data providers that are in the news. A search field may also be utilized to search applicable information that may be displayed to the user interface 700, 800. Any number of windows, sub-windows, pop-ups, and so forth may be utilized or opened within the user interface 700, 800. The user interface 700 may include settings, configurations, parameters, or configurations that custom how, when, and what data, tokens, and information are displayed to the user.

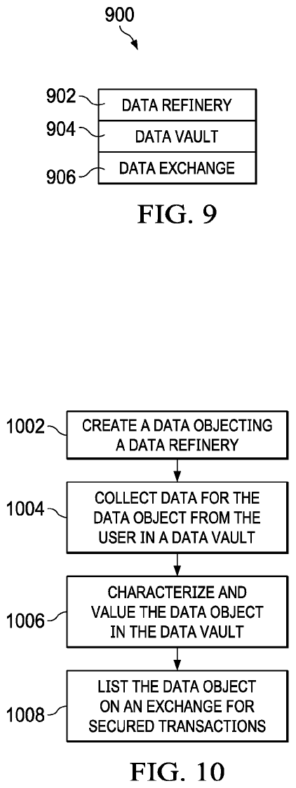

FIG. 9 is a pictorial representation of a platform 900 for monetizing data in accordance with an illustrative embodiment. The platform 900 may include a data refinery 902, a data vault 904, and a data exchange 906. The platform 900 of FIG. 9 may be representative of one or more devices, such as the servers 116, data platform of FIG. 1, or other smart networked device implementing specific hardware, software, firmware, and/or sets of instructions. The platform 900 including the data refinery 902, data vault 904, and the data exchange 906 may function as separate platforms or an integrated platform.

The data refinery 902 is utilized to create data objects and capture applicable data to include the data objects. In one embodiment, the data refinery 902 may be positioned within the user's existing system to capture data that is already received, entered, gleaned, or otherwise determined by the existing system. The data object may be created to store all, portions, or types of data associated with the user (e.g., individual, couple, family, company, organization, group, entity, etc.).

The data vault 904 is utilized to securely store the data objects and add, modify, and improve the associated data. In one embodiment, the data vault may be utilized to collect, characterize, and value the data. The data vault 904 may also determine the pace at which new data objects are added or updated as well as the types of data. For example, the data vault 904 may determine that information relevant to two of the user's clients including company preferences for wireless services and legal services are added to the data vault 904 each day. The data vault 904 may be a physical or virtual storage and vault that securely stores information. In one embodiment, the data objects may be deidentified to remove identifying information to prevent hacking, identity theft, and other unwanted or prohibited utilization of data. The data vault 904 may also assign an initial value for the data object. The value may be associated with similar data, going rates, completeness of the data, the type of data, the user supplying the data, historical information, and so forth. The value may change at any time based on a determination of the platform 904 (i.e., the data vault or data exchange).

The data exchange 906 is utilized to price and perform transactions for the data objects. In one embodiment, the data exchange 906 creates a ticker associated with the data object. The ticker may be associated with the data object(s) for a user. The data exchange 906 allows the data objects to be priced and purchased. In one embodiment, exchange may utilize secure tokens to access the data. For example, transactions involving the data may represent a key for accessing the purchased or leased data. For example, the tokens may include an encryption key, password, biometric, or other secure identifier for accessing the data object from the data vault or other stored location.

FIG. 10 is a flowchart of a process for monetizing data in accordance with an illustrative embodiment. The process of FIG. 10 may begin by creating a data object in a data refinery (step 1002). The data object may be associated with particular users and may include many distinct categories and types of data associated with one or more time periods. The data refinery may be physically or virtually integrated with the user's systems. For example, one or more networks and cloud devices and systems may be utilized for the process of FIG. 10.

Next, the platform collects data for the data object from the user in a data vault (step 1004). The data is collected and added to the data object. In some instances, new data may replace or modify old data to ensure that the data objects are up to date. In one example, the data object is a user profile.

Next, the platform characterizes and values the data object in the data vault (step 1006). The platform may determine when, how, and what types of data are received to characterize the data as well as the pace of received data. The platform may also value the data received. The value may represent a fixed and/or starting/initial value for the data object.

Next, the platform lists the data objects on an exchange for secured transactions (step 1008). The platform may utilize a ticker, such as GCO.1w or DDT.TCH1, to designate the user or type of data. The ticker may be utilized to perform any number of real-time, market, limit, short, option, or other transactions. Tokens traded may utilized the ticker to identify the data and access the data. For example, the tokens may include keys or indicators for accessing the data object. The exchange may represent an open exchange open to any number of lawful parties that are registered or otherwise authorized to perform transactions. During step 1008, the data assets may be tokenized and converted into named trading assets of a data source provider. The objectified data assets may allow of the direct control, valuation, and monetization of the data. Monetization may be performed through a process that is achieved through data refinement, objectification, virtual reality tokenization, valuation, ticker assignment, and open transactions as described for FIG. 10. Trades on the exchange may be executed privately or publicly utilizing digital currencies, hard currencies, charitable contributions, trades, and credits

The illustrative embodiments provide a secure system, method, platform and devices for securing and maximizing the value of data into a tradable asset. Data may be collected, updated, aggregated, processed, analyzed, and utilized in real-time market conditions in a manner that is approved of and accepted by the user. For example, the collected data is disassociated from the user (herself, himself, itself) to prevent identity theft, corporate/organization/entity data theft, phishing, hacking or other forms of illegal, unscrupulous, or improper data theft or manipulation The data may be associated with a secure key accessed through a blockchain token to securely monetize the data for the benefit of the user. Any number of transactions may be performed utilizing a data exchange including transactions that are performed on exchanges, such as the New York Stock Exchange, Nasdaq, London Stock Exchange, Chicago Board Options, Exchange, and so forth. The platform may automatically match data with individuals, companies, entities, groups, or organizations who find the data most valuable and are willing to best compensate the user for the data. The transparent and open marketing of the data allows users to take back control of their data, how it is used, and how the user is compensated for providing their data in a very secure way.

Turning now to providing additional information regarding data valuations, data valuation may be performed at any time for different selections, groups, amalgamations, cohorts, populations, data sets, combinations, and so forth. As previously noted, commercial and consumer data may be generated from countless online, retail, digital, mobile, and service-based data sources. Data is often already used to support a business, organization, or entity's business model. The illustrative embodiments differentiate and value data in categories related to ongoing data accumulation of variable commercial and consumer data points by determining and measuring when and if certain data points are in a constant state of flux, perennial, or static/non-changing.

The data may be collected from various data collection sources and integrated into a data pool as raw data that may then be categorized, assimilated, processed, and analyzed for marketable and actionable insights. The unique nature of raw data may allow it to have potentially limitless end uses and depending on data reliability and the user intention, the uses cases may vary, change, and adapt over time. The value for the data in the data pool may be driven for the supply and demand for all or portions of the data pool, data points, and so forth. Completeness of user profiles may also provide added value for the data reliability and inherent value with various data marketplaces.

Several of the key components of data reliability may be broken into data that is anchored into the user profile and non-changing data that is a constant state of data flux. The data flux is inherent in data categories with a limited time window for the data to have maximum value for a specific category. Data flux may be inherent in data categories with a limited time window for the data to have maximum value for a specific category.

Influx data value may be combined with perennial data or anchored data points allowing profile data to gain value overtime as data points are added, updated, and user profiles become more complete and robust. The same constant state of data flux may also allow data profiles or data sources to lose value over time if the data becomes stale, non-targetable, or less relevant to marketers.

Turning now to the data derivatives marketplace described in the various embodiments (e.g., systems, methods, platforms, devices, computer implemented processes, etc.). The data derivatives market provides the ability to track transactions (including futures and forward contracts) based on the speculation, quantification, and valuation of the underlying data assets. The platform may classify and value profile data elements by 1) grouping each data element into distinct categories, and 2) creating repositories that measure the fluctuating value of commercial and consumer data elements when any element of the data points that may be monetized by a 3^{rd} party. The data may be categorized and grouped into data repositories and tracked in real-time through exchanges of targeting data pricing based on known CPC, CPM, and CPA prices. The platform may measure the degree of value and success based on the availability of user profile data points and when and which relevant data elements are used when monetizing the data through any 3^{rd} party targeting of a data repository.

The platform may measure and value each utilization of specific data profile elements in the repository and may measure and value large corporate data repositories providing both leading and trailing indicators measure the fluctuating value of that data when used for targeting online advertisements to a device or targeting user for real-world marketing-based advertising.

The illustrative embodiments provide a method for providing visibility as to how potential value is assigned to data based on content from multiple owners of personal, corporate, or private datasets in a data pool for measuring, monitoring, and evaluating increases or decrease in the value and relevancy of their data. Success or true value of data acquisitions may often be measured after the data transaction has been executed (e.g., changes after integration). As a result, the illustrative embodiments provide a method for meaningfully measuring the current and future value of corporate data as a standalone or when combined with other outside owned groups of data.

The system and platform herein described values each commercial and consumer data pool and each unique commercial and consumer profile as a data asset with value derived through the measurement of each data point's availability and the influx and saturation point of perennial commercial and consumer data points within a single or a combine data pool for corporate commercial and consumer profiles. Current and future data utilization and desired end value of each potential data acquisition and transaction are determined as an additional value indicator used in the data valuation process. Futures transactions may allow for a more measurable method for determining the value of data over time based on historical transactions. The platform may track and segment a variety of data points to measure and value each data point based on its targeted effectiveness measured in part by propagating each user profile data point with relevant and current data points.

In one embodiment, the platform may not specifically target advertisements to an individual but instead utilizes data measurement and valuation to place value on data quality, data characteristics, data business relevance, and data impact creating new financial performance indicators for monetization of the data for data brokers. The platform may be utilized to perform indirect or direct targeted advertisements. For example, analysis and valuation of corporate data may be utilized to determine effective monetization.

Data that is temporary or ever-changing may have a short window for utilization with a limited shelf life for relevancy. Examples of data with a short time window for value may include location (e.g., GPS, latitude and longitude, proximity, beacon information, etc.), video feed data, text data in parentheses e.g., social media generated, determined from applications, etc.) metadata, fixed asset data, and other similar user profile data points that are in a constant state of flux or that are valued differently than fixed user profile data. Specific examples of fluctuating data with a short shelf life may include wedding planning information, engagement information, pregnancy information, baby planning information, unemployment data, job searching information, house or apartment hunting, dating information, travel plans, and so forth. In data valuation, the relevancy of data may be determined by how current the data is, how relevant the date is, and how accurately the data may be used to target customized ads or customized product marketing to an individual or groups. The illustrative embodiments provide a system, method, and platform that may more accurately measure and value prices for each data element (e.g., CPC, CPM, CPA, etc.) based on a longer or shorter window of data relevancy. Specific data elements that have a longer period of relevancy may be given a higher value. In some examples, the data with the highest value may reside in the profile data is a permanent targetable data profile element.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

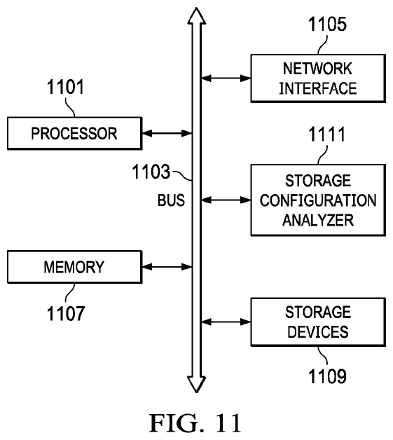

FIG. 11 depicts a computing system 1100 in accordance with an illustrative embodiment. For example, the computing system 1100 may represent a device, such as one or more of the devices 101 of FIG. 1. The computing system 1100 includes a processor unit 1101 (possibly including multiple processors, multiple cores, multiple nodes, and/or implementing multi-threading, etc.). The computing system includes memory 1107. The memory 1107 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 1103 (e.g., PCI, ISA, PCI-Express, HyperTransport®, InfiniBand®, NuBus, etc.), a network interface 1105 (e.g., an ATM interface, an Ethernet interface, a Frame Relay interface, SONET interface, wireless interface, etc.), and a storage device(s) 1109 (e.g., optical storage, magnetic storage, etc.). The system memory 1107 embodies functionality to implement embodiments described above. The system memory 1107 may include one or more functionalities that store content, blockchain data, parameters, application, user profiles, and so forth. Code may be implemented in any of the other devices of the computing system 1100. Any one of these functionalities may be partially (or entirely) implemented in hardware and/or on the processing unit 1101. For example, the functionality may be implemented with an application specific integrated circuit, in logic implemented in the processing unit 1101, in a co-processor on a peripheral device or card, etc. Further, realizations may include fewer or additional components not illustrated in FIG. 11 (e.g., video cards, audio cards, additional network interfaces, peripheral devices, etc.). The processor unit 1101, the storage device(s) 1109, and the network interface 1105 are coupled to the bus 1103. Although illustrated as being coupled to the bus 1103, the memory 1107 may be coupled to the processor unit 1101.

The features, steps, and components of the illustrative embodiments may be combined in any number of ways and are not limited specifically to those described. For example, the description and figures for FIGS. 1-10 are applicable, combinable, and applicable in various contemplated combinations. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for performing transactions for data, comprising:
grouping the data into a data asset;
associating the data asset with a data platform including one or more servers and databases;
receiving transaction information for the data asset;
performing one or more transactions for the data asset based on the transaction information, wherein the one or more transactions are performed utilizing the data platform; and
providing verification of the transaction for the data asset.

2. The method of claim 1, further comprising:
receiving a selection from a user to monetize data associated with the user; and
compiling the data associated with the user, wherein the user is one of the plurality of sources.

3. The method of claim 1, wherein the grouping further comprises:
associating the data with an individual, business, entity, or organization.

4. The method of claim 1, wherein the receiving is performed in response to an opt in from the plurality of sources.

5. The method of claim 1, wherein the one or more transactions are a futures transaction for the data.

6. The method of claim 1, wherein the one or more transactions are performed utilizing blockchain.

7. The method of claim 6, wherein the verification is recorded in a blockchain ledger.

8. The method of claim 1, wherein the transaction information includes at least a price for the data asset, parties bound by the transaction, and an executing date.

9. The method of claim 1, further comprising:
communicating the transaction information to parties involved in the transaction or authorized to see the transaction.

10. The method of claim 1, wherein the data platform is a trading platform for performing the one or more transactions, wherein the data platform communicates with a plurality of devices executing a mobile application in communication with the data platform.

11. A system for performing transactions for data, comprising:
a plurality of electronic devices executing a data application, the data application is configured to receive data from a plurality of sources;
a data platform accessible by the plurality of wireless devices executing the data application through one or more networks, wherein the data platform groups the data received from the plurality of sources, associates the data with a platform, receives transaction information for the data, performs one or more transactions based on the transaction information, and provides verification of the transaction.

12. The system of claim 11, wherein the data platform further:
receives a selection from a user to monetize data associated with the user; and
compiles the data associated with the user as part of receiving data from the plurality of sources.

13. The system of claim 11, wherein the data platform further:
communicates the transaction information to parties involved in the transaction or authorized to see the transaction.

14. The system of claim 11, wherein the one or more transactions are performed utilizing blockchain, and wherein the verification is recorded in a blockchain ledger.

15. A data platform, comprising:
a server including a processor for executing a set of instructions and a memory for storing the set of instructions;
a plurality of databases in communication with the servers configured to store data;
wherein the instructions are executed by the processor for the server to group the data, associate the data with the data platform, receive transaction information for the data, perform one or more transaction based on the transaction information, and provide verification of the transaction.

16. The data platform of claim 15, wherein the set of instructions are further executed to:
receive a selection from a user to monetize data associated with the user; and
compile the data associated with the user.

17. The data platform of claim 16, wherein the set of instructions are further executed to:
associate the data with an individual, business, entity, or organization.

18. The data platform of claim 16, wherein the set of instructions are further executed to:
communicate the transaction information to parties involved in the transaction or authorized to see the transaction.

19. The data platform of claim 16, wherein the transaction is performed utilizing blockchain, and wherein the verification is recorded in a blockchain ledger.

20. The data platform of claim 16, wherein the transaction information includes at least a price, parties bound by the transaction, and an executing date.
